(19) United States
(12) Patent Application Publication
(10) Pub. No.: US 2021/0001822 A1
(43) Pub. Date: Jan. 7, 2021

(54) TIRE TREAD WIPER

(71) Applicant: P.P.H. ,,Polmar” Dionizy Szczerba, Lubliniec (PL)

(72) Inventor: DIONIZY SZCZERBA, Lubliniec (PL)

(21) Appl. No.: 16/920,690

(22) Filed: Jul. 4, 2020

(30) Foreign Application Priority Data
Jul. 4, 2019 (PL) P.430493

(51) Int. Cl. B60S 3/04

(52) U.S. Cl. CPC B60S 3/04

(57) ABSTRACT

A mat for cleaning tyre tread of mud, sand and other similar dirt which can accumulate in the tyre tread, made of hot-galvanised steel grating (1) with brushes (2) in a form of cubes (2a) placed in the grating meshes, with bristle (2b) fixed in the cubes (2a) and protruding above the upper surface of the grating (1), whereby the brushes (2) in the grating (1) are fixed in a hot-galvanised steel supporting structure combined with the grating (1), with seats (4) in the supporting structure with embedded brushes (2) and seats (5) with embedded flat bars (1a) making the grating (1) is characterised by that the supporting structure has a form of strips (3) with seats (4) for embedding the brushes (2) profiled alternately along their length and seats (5) where the flat bars (1a) making the grating (1) are inserted, whereby the upper surface of the flat bars (1a) is welded to the surface of the strips (3) adjacent to them.

### CROSS REFERENCE TO RELATED APPLICATIONS

This application claims a priority of the Polish Patent Application No.: P.430493, filed on Jul. 4, 2019, the content of which is hereby incorporated by reference.

### FIELD OF INVENTION

This disclosure relates to a mat for cleaning tyre tread of mud, sand and other similar dirt which can be accumulated in the tyre tread. The solution is intended for cleaning tyres of wheeled vehicles, such as passenger cars, trucks, specialised vehicles, trailers and semitrailers, electric trucks, including forklift trucks and other structures moving on rubber wheels with tyre tread.

### BACKGROUND

A mat for cleaning wheeled vehicle tyre tread and shoe soles, composed of a grating with brushes fixed in the grating one next to another and filling its entire space is known from international patent application WO2015127963. Each brush has a form of a bristle strip running along one side of the grating, with bristles fixed in the bristle strip. The bristle on the strip is arranged in tufts, each placed in its seat in the grating. The brushes in the grating are fixed by introducing the opposite ends of the bristle strips onto their supporting beams, with the beams underneath arranged perpendicularly to the bristle strips, and mounted on the opposite sides of the grating. The brush ends in the beam are placed in the seats which determine the distance between them. The bristle of the mat wears in a non-uniform manner and it often happens that the bristle from one or few adjacent tufts in one or more bristle strips is pulled out, crushed or broken. If one or two adjacent bristle tufts are damaged, in order to maintain high performance of the mat as a whole, the entire brush is replaced, in spite of the fact that other bristle tufts are not damaged. The impossibility to replace single bristle tufts is the shortcoming of the solution.

A grating or mat with basically the same structure as mentioned in the presented solution is also known from German patent application DE3821722A1. In the solution according to the German application, similarly to the previous one, brushes come in a form of bristle strips mounted one next to another in a framework, preferably grating. In the presented solution it is not possible to replace only the worn bristle tuft. Only the whole bristle carrier can be replaced. The structure presented below reveals a possibility to replace single bristle tufts.

A mat for wheeled vehicles tyre tread cleaning composed of grating with rectangular meshes is known from popular use. In each or every other mesh there is a basket, where a brush is placed in a form of a cube permanently fixed in the basket, with the fixed bristle tuft coming from the cube. The cube in the box is fixed by point squeezing of the opposite walls of the basket into their adjacent cube sides. The baskets in the grating meshes are fixed by squeezing—folding the tabs which stem from them around the opposite edges of the flat bars making the grating and congruent to the basket. In the reference solution one brush is composed of one bristle tuft, and consequently the advantage of the solution is that if only one bristle tuft is damaged only this bristle tuft is replaced, rather than the whole brush which contains several or a dozen or so fully functional bristle tufts, as in the first and second solution. With regard to the fact that the reference mat is intended for cleaning vehicle wheels of high weights, the basket and the mounting tabs which stem from it are made of relatively thick metal plate, ca. 0.5 mm thick. The shortcoming of the reference solution is that permanent spot clamping of the basket with the brush cube makes it impossible for the user of the mat to replace the brush on their own. Furthermore, the need to ensure high load capacity of the basket fixing in the grating requires using specialised service equipment to embed the basket in the grating. Consequently, the user of the mat is not able to replace the basket with the damaged cube, either. The presented solution is the subject of the Polish industrial design Rp.18646 called “Cleaning brush for mats made of metal flat bars”.

A tyre tread cleaning mat is known from the Polish utility model Ru. 070757, composed of a grating with baskets mounted in the grating rectangular meshes, whereby the brushes are mounted in a form of cubes fixed in the basket, with a bristle tuft fixed in and coming out of the cube. The brush cubes are featured with catches which stem from them and overlap the edges of the opening in the basket which they pass through. Each basket is fixed in its assigned grating mesh by folding—squeezing the tabs, which stem from it on its both opposite sides upwards, around the top and bottom edges of the flat bars which form the grating. Fixing the brush in the basket using a brush catch snapped in the basket bottom enables easy replacement of the brush by non-qualified staff with an appropriate tool. Fixing each basket using its tabs which overlap the flat bars is time-consuming and increases the production costs.

A mat according to this structure design is permanently subject to loads of the passing vehicles. During such loads the bottom areas of the flat bars press against the tab sections underneath. In the abovementioned structure the dirt particles, in particular sand from the tyre treads of the vehicles driving through the mat, get into the space between the congruent areas of the tabs and flat bars. The presence of sand grains or other similarly hard fine particles between the lower surface of the flat bars and their adjacent surface of the tabs, at a significant pressure, push the fine particles into the tabs, which leads to the material swelling, loosening of the baskets with the brushes and accelerated corrosion.

### SUMMARY

The objective according to the solution is a structure of the mat where the abovementioned shortcomings have been eliminated.

A tyre tread cleaning mat made of hot-galvanised steel grating with brushes in a form of cubes placed in the grating meshes, with bristle fixed in the cubes and protruding above the upper surface of the grating, whereby the brushes in the grating are fixed in a hot-galvanised steel supporting structure combined with the grating, with seats in the supporting structure with embedded brushes and seats with embedded flat bars making the grating, according to the disclosure is characterised by that the supporting structure has a form of strips with seats for embedding the brushes profiled alternately along their length and seats where the flat bars making the grating are inserted, whereby the upper surface of the flat bars is welded to the surface of the strips adjacent to them.

Creating a supporting structure for the brushes (cubes with bristle) as in the solution according to the solution, in a form of strips welded with the grating, greatly accelerates the mat production process. Combining the supporting structure of the brushes with the grating by welding eliminates the problem of premature erosion. The solution allows the transfer of much higher loads caused by the vehicle wheels onto the cleaning components. A more stable structure enables equipping the cleaning grating with anti-slip elements at sloped ramps and with drying elements.

### BRIEF DESCRIPTION OF THE DRAWINGS

The subject of the disclosure is presented in the drawing, where

FIG. 1 shows the side view of the strip embedded in the grating shown in a cross-section along the strip length;

FIG. 2 shows a part of the strip and the grating presented in FIG. 1 in magnification;

FIG. 3 shows the axonometric view of the mat;

FIG. 4 shows the axonometric view of the corner part of the mat grating with a part of one strip with one brush decomposed;

FIG. 5 shows the axonometric view of the corner part of the grating;

FIG. 6 shows the axonometric view of the strip; and

FIG. 7 shows the axonometric view of the brush.

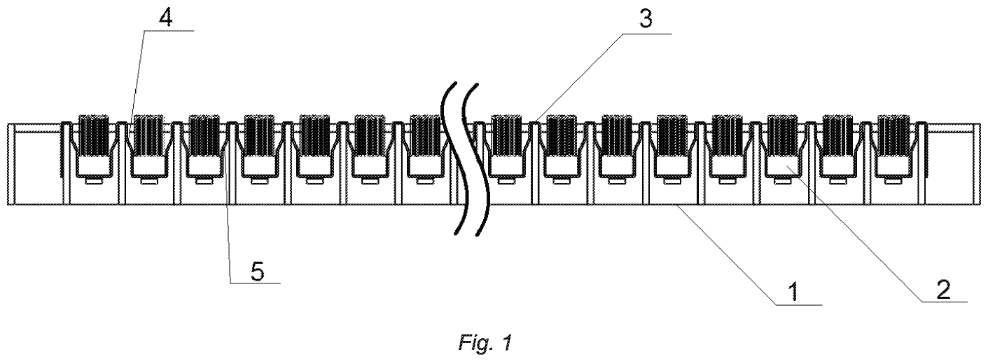

### DETAILED DESCRIPTION OF THE PREFERRED EMBODIMENTS

The description of illustrative embodiments according to principles of the present solution is intended to be read in connection with the accompanying drawings, which are to be considered part of the entire written description. In the description of embodiments of the solution disclosed herein, any reference to direction or orientation is merely intended for convenience of description and is not intended in any way to limit the scope of the present solution. Relative terms such as “lower”, “upper”, “horizontal,” “vertical,” “above,” “below,” “up,” “down,” “top” and “bottom” as well as derivative thereof (e.g. “horizontally,” “downwardly,” “upwardly,” etc.) should be construed to refer to the orientation as then described or as shown in the drawing under discussion. There relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both moveable or rigid attachments or relationships, unless expressly described otherwise. Moreover, the features and benefits of the solution are illustrated by reference to the exemplified embodiments.

Accordingly, the solution expressly should not be limited to such exemplary embodiments illustrating some possible non-limited combination of features that may exist alone or in other combination of features; the scope of the invention being defined by the claims appended hereto. This disclosure describes the best mode or modules of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

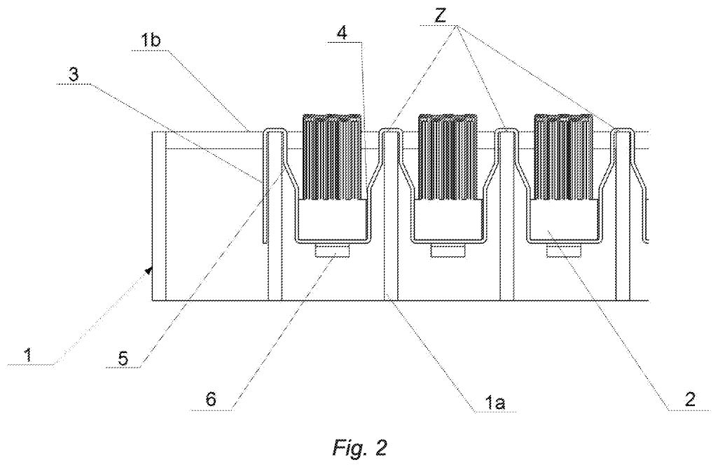

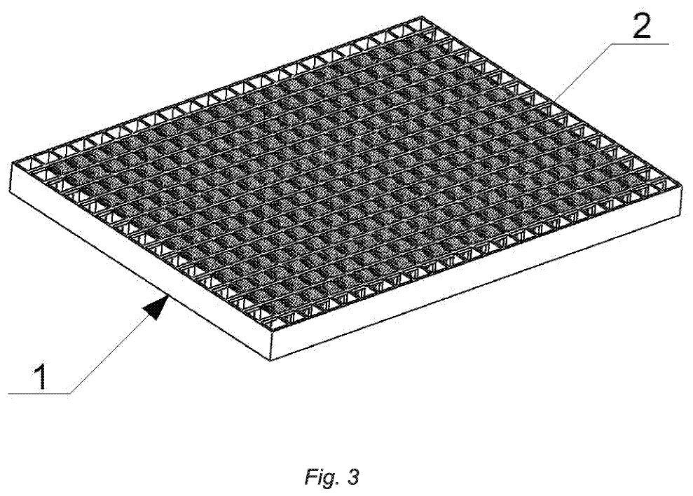

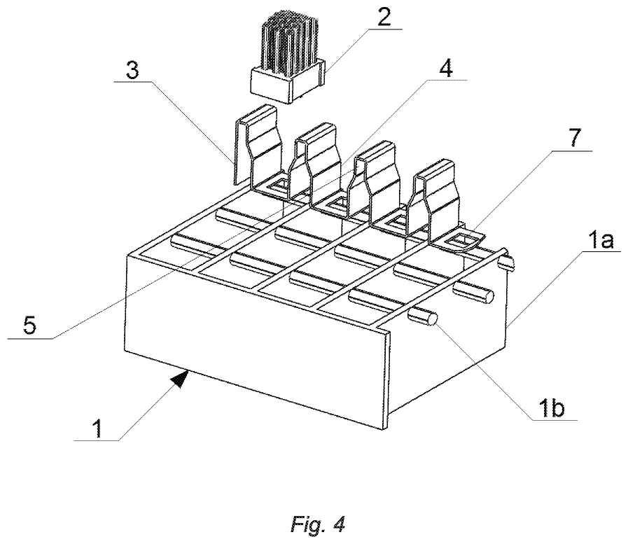

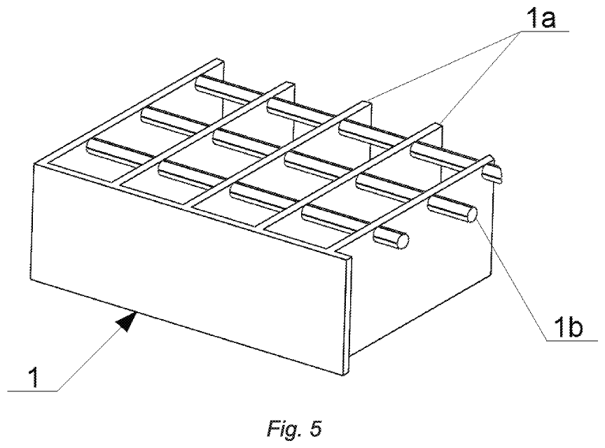

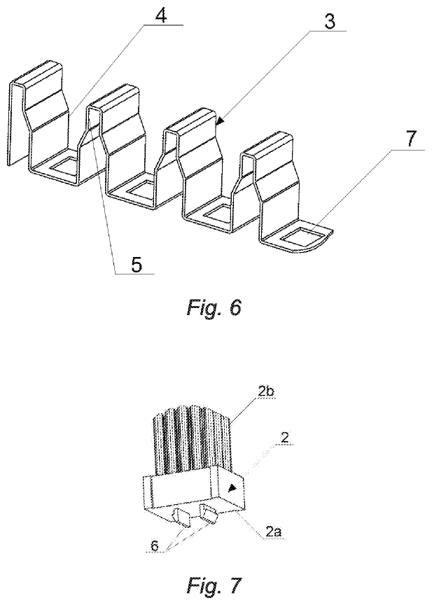

A tyre tread cleaning mat in the embodiment according to the present disclosure is composed of rectangular grating 1 with rectangular meshes. Grating 1 has a form of a framework with flat bars 1a arranged one next to another and with bars 1b crossing them at a right angle. In every mesh of grating 1 there are brushes 2 in a form of cubes 2a, with bristle 2b fixed in cubes 2a and protruding above the upper surface of grating 1. In one mesh of grating 1 one brush 2 is placed, whereby individual/selected meshes of grating 1 can also be empty. Brushes 2 in grating 1 are fixed in a supporting structure combined with grating 1, whereby the supporting structure has a form of many parallel strips 3—one strip 3 holds one row of meshes. Along the longest side of each strip 3 there are profiled upward oriented seats 4 located, where brushes 2 are fixed, and downward oriented seats 5, where flat bar 1a which makes the grating is inserted. Seats 4 for brushes 2 and seats 5 for flat bars 1a in strips 3 are arranged alternately—one seat 4 for brush 2 between seats 5 for adjacent flat bars 1a. Grating 1 and strips 3 which form the supporting structure for brushes 2 are made of hot-galvanised steel. The upper surface of each flat bar 1a is welded with the surfaces of strips 3 adjacent to it, or more precisely with the surfaces of strips 3 sections which make the bottoms of seats 5 for flat bars 1a—in FIG. 2 item Z. The following are preferably used to make grating 1: 2-5 mm thick and 20-70 mm wide flat bars 1a, 0.5-1.0 mm thick and 20-70 mm wide strip 3, and 2-5 mm diameter bars 1b. Strip 3 is welded with grating 1 using known and common methods of galvanised steel welding. For instance, a welding machine can be used for welding, in order to weld elements by accurately controlling the current and pressure exerted on the welded area. The cube of brush 2 in strip 3 is fixed by catch 6 formed on its lower surface in a form of two noses resting on feet, arranged in parallel to one another and oriented in the opposite directions, where one nose overlaps one edge and the other nose overlaps the other, opposite, edge of a rectangular hole 7 made in each seat 4 of strip 3. Cube 2a of brush 2 along its whole side edges has tabs which overlap the opposite edges of seat 4 side walls. The above stabilises the position of cube 2a in the supporting structure. Cube 2a of brush 2 with catch 6 is made as one element. Brushes 2 in grating 1 are arranged in all meshes or in a chessboard pattern. Brush 2 is made of plastic.

While the present invention has been described at some length and with some particularity with respect to the several described embodiments, it is not intended that is should be limited to any such particulars or embodiments or any particular embodiment, but it is to be construed with references to be appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

1. A tyre tread cleaning mat made of a hot-galvanised steel grating with brushes in a form of cubes placed in grating meshes, with bristle fixed in the cubes and protruding above an upper surface of the grating, wherein
the brushes in the grating are fixed in a hot-galvanised steel supporting structure combined with the grating, with seats in the supporting structure with embedded brushes and seats with embedded flat bars that make the grating, wherein
the supporting structure has a form of strips (3) with seats (4) for embedding the brushes (2) profiled alternately along their length and seats (5) where the flat bars (1a) that make the grating (1) are inserted, wherein
an upper surface of the flat bars (1a) is welded to a surface of the strips (3) adjacent to them which make the bottoms of the seats (5) for the flat bars (1a).

2. The tyre tread cleaning mat according to claim 1, wherein the mat is composed of rectangular grating (1) with rectangular meshes.

3. The tyre tread cleaning mat according to claim 2, wherein the grating (1) is in a form of a framework with flat bars (1a) arranged one next to another and with bars (1b) crossing them at a right angle.

4. The tyre tread cleaning mat according to claim 1, wherein in one mesh of grating (1) one brush (2) is placed, wherein individual, selected meshes of grating (1) can remain empty.

5. The tyre tread cleaning mat according to claim 1, wherein the supporting structure has a form of many parallel strips (3), wherein one strip (3) holds one row of meshes.

6. The tyre tread cleaning mat according to claim 1, wherein along the longest side of each strip (3) there are the profiled upward oriented seats (4) located, wherein the brushes (2) and the downward oriented seats (5) are fixed.

7. The tyre tread cleaning mat according to claim 1, wherein the seats (4) for the brushes (2) and the seats (5) for the flat bars (1a) in the strips 3 are arranged alternately—a one seat (4) for the brush (2) between the seats (5) for the adjacent flat bars (1a).

8. The tyre tread cleaning mat according to claim 1, wherein the grating (1) comprises the 2-5 mm thick and 20-70 mm wide flat bars (1a), the 0.5-1.0 mm thick and 20-70 mm wide strip (3), and the 2-5 mm diameter bars (1b).

9. The tyre tread cleaning mat according to claim 1, wherein a cube of the brush (2) in the strip (3) is fixed by the catch (6) formed on its lower surface in a form of two noses resting on feet, arranged in parallel to one another and oriented in the opposite directions, wherein
one nose overlaps one edge and the other nose overlaps the other, opposite edge of a rectangular hole (7) made in each seat (4) of the strip (3).

10. The tyre tread cleaning mat according to claim 1, wherein the cube (2a) of the brush (2) along its whole side edges has tabs which overlap the opposite edges of the seat (4) side walls what stabilises a position of the cube (2a) in the supporting structure, wherein
the cube 2a of the brush 2 along its whole side edges has tabs which overlap the opposite edges of the seat 4 side walls what stabilises a position of the cube (2a) in the supporting structure, and wherein
the cube (2a) of the brush (2) with the catch 6 is made as one element.

11. The tyre tread cleaning mat according to claim 1, wherein the brushes (2) in the grating (1) are arranged in all meshes or in a chessboard pattern, wherein the brush (2) is made of plastic, wherein the cube (2a) of the brush (2) with the catch (6) is made as one element.

12. The tyre tread cleaning mat according to claim 1, wherein the brushes (2) in the grating (1) are arranged in all meshes or in a chessboard pattern.

13. The tyre tread cleaning mat according to claim 1, wherein creating a supporting structure for the brushes, in a form of the strips welded with the grating, accelerates the mat production process.

14. The tyre tread cleaning mat according to claim 1, wherein combining the supporting structure of the brushes with the grating by welding eliminates the problem of premature erosion.

15. The tyre tread cleaning mat according to claim 1, wherein the mat allows a transfer of much higher loads caused by the vehicle wheels onto the cleaning components, wherein a more stable structure enables equipping the cleaning grating with anti-slip elements at sloped ramps and with drying elements.
